(19) United States
(12) Patent Application Publication
(10) Pub. No.: US 2003/0034647 A1
(43) Pub. Date: Feb. 20, 2003

(54) Removable pipe coupler

(76) Inventor: Elmont E. Hollingsworth, Austin, TX (US)

Correspondence Address: Jack V. Musgrove, 2911 Briona Wood Lane, Cedar Park, TX, 78613, US

(21) Appl. No.: 10/212,921

(22) Filed: Aug. 6, 2002

Related U.S. Application Data
(60) Provisional application No. 60/313,102, filed on Aug. 17, 2001.

(51) Int. Cl. F16L 33/16

(52) U.S. Cl. 285/105; 285/242; 285/423; 285/323

(57) ABSTRACT

A pipe coupler includes a gripping element adapted to engage an outer surface of a pipe end to oppose a pull-out force on the pipe end, and a torque drive mechanism which rotates the gripping element to induce longitudinal movement of the gripping element along the pipe end in an opposite direction. The gripping element may take the form of a collet having a threaded inner surface, and the torque drive mechanism incorporated in a back-up ring that surrounds the collet. The torque drive mechanism may be provided by an inwardly extending, longitudinal flange which is stamped out of the metallic back-up ring, and which engages a longitudinal notch in the collet. This design allows the intentional removal of the coupler at any time that the coupling is not under a large axial load.

### CROSS-REFERENCE TO RELATED APPLICATION

This application claims priority to U.S. provisional patent application No. 60/313,102, filed on Aug. 17, 2001.

### BACKGROUND OF THE INVENTION

1. Field of the Invention

The present invention generally relates to devices and articles for joining conduits such as tubes, pipes or ducts, and more particularly to a coupler design adapted to join polymeric pipe ends or otherwise prepare a pipe end for connection to another structural member.

2. Description of the Related Art

Pipe couplings are well-known in the art, and are manufactured in a variety of designs and used to join many different types of pipes or conduits. Early pipe joining techniques were directed to metal pipe, but plastic (polymeric) pipe has now become the primary form used by the industry, particularly due to the imposition of governmental regulations that relate to piping for utilities such as water or natural gas. These conduits are provided in different sizes, shapes and materials.

Many problems arise in the joining of pipe, including plastic pipe, whether the joint is a butt end (in-line), corner, or tee connection. One significant problem is ensuring an adequate seal at the joint. The seal must be able to withstand certain thermal stresses and minimum pullout forces, so any coupling device must maintain its integrity upon the application of these forces.

A related problem in this regard is the manner of attaching a coupler to plastic pipe, such as polyethylene pipe. Polyethylene has very poor adhesion properties, and it is very difficult to secure a coupler to the pipe itself. The joint seal cannot be considered reliable if the pipe coupler is not securely affixed to the pipe end. There are systems adapted for fusion bonding of couplers to a pipe end, but these systems are complicated and costly.

A further problem in the joining of pipe relates to the design of the pipe end. Some pipes may have, e.g., threading or a bell-and-pipe slip construction that facilitates pipe joining. Plain piping (i.e., pipes having an unthread end with constant inner and outer wall diameters) presents additional difficulties since no features are present which may be used to effectuate the joint.

One approach for joining pipe that attempts to address the foregoing problems involves the use of stab-type couplings. A stab coupling is generally used for smooth-ended (flareless) pipes. The stab couplers typically have a gripper ring or collet which is adapted to contract tightly about the pipe end and engage the pipe by means of frictional forces to resist pull-out. Prior art stab couplings have used both solid and split-type gripper rings or washers, and various spring-type elements.

Stab couplings are relatively easy to install, by severing the end of the tube at right angles, and then chamfering the tube end to facilitate insertion of the tube into the coupling body. Gripping of the tube surface and the resistance to attempted withdrawal is based on the “Chinese finger puzzle” principle, wherein an increased pull-out force results in increased frictional forces which engage the collet with the tube end. In other words, the greater the pullout force, the more securely the tube becomes seated within the coupling.

One stab-type coupling is shown in U.S. Pat. No. 4,299,025. In that design, a coupling body surrounds several components, including a retaining collet that has a toothed or serrated interior surface for engaging the pipe end. The outer surface of the retaining collet has a tapered construction which converges in the direction opposite the pipe end. A cross-section of the retaining collet showing the serrations is depicted in FIG. 1. A frusto-conical, metallic back-up ring is interposed between the coupling body and the retaining collet, and serves to surround and cooperate with the retaining collet to exert an inwardly-directed gripping force. The back-up ring is shown in FIG. 2. In this manner, if a pull-out force is exerted on the pipe (i.e., an attempt is made to remove the pipe from the coupler), any slight movement of the pipe will push the tapered collet into the rigid metallic back-up ring, resulting in further compression of the collet, and tighter engagement of the collet serrations with the outer surface of the pipe end.

There are still several problems with the foregoing design. For example, the '025 stab coupler is not removable. A craftsperson may want to remove the pipe coupler so as to reuse it, replace the pipe or replace a dead end and add to the system. A common practice is to install a piping system for gas or water supplies to an empty lot and dead end it. Later when a house is built on the lot, one can remove the dead end and connect to the supplied utility. This problem has lead to several specific adaptations of the stab couplings such as U.S. Pat. No. 6,050,613 to make removable end closures, some of which are replaceable. It is also not possible to test the coupler without already having it installed on the pipe end. It would, therefore, be desirable to devise an improved stab coupler which provides a superior mechanical attachment of the pipe coupler to the pipe end, and overcomes the foregoing problems. It would be further advantageous if the coupler could be installed without the need for a special tool or equipment.

### SUMMARY OF THE INVENTION

It is therefore one object of the present invention to provide an improved pipe coupler.

It is another object of the present invention to provide an improved design for a stab-type pipe coupler which utilizes an internal gripping ring or collet.

It is yet another object of the present invention to provide a stab-type pipe coupler which is easily installed as well as removable and reusable.

The foregoing objects are achieved in a pipe coupler generally comprising a gripping element which is adapted to engage an outer surface of the pipe end to oppose a pull-out force on the pipe end in a first direction, and a torque drive mechanism which rotates the gripping element to induce longitudinal movement of the gripping element along the pipe end in a second direction which is opposite the first direction. In the illustrative embodiment, the gripping element is a collet having a threaded inner surface, and the torque drive mechanism is incorporated in a back-up ring that surrounds the collet. The outer surface of the collet is frusto-conical in shape and matches the frusto-conical inner surface of the back-up ring such that, when the collet is forced against the backup-ring, the collet is further compressed toward the pipe end. The torque drive mechanism may take the form of an inwardly extending, longitudinal flange which is stamped out of the metallic back-up ring, and which engages a longitudinal notch in the collet. In this manner, the craftsperson may grasp the pipe end with one hand while turning the back-up ring with the other hand, to induce rotation of the collet about the pipe, which also moves the collet longitudinally along the pipe due to engagement with the threading.

The foregoing construction allows the intentional removal of the coupler at any time that the coupling is not under a large axial load. The coupler may thus be reused. It can also be moved in both directions along the pipe during assembly (pushing one direction, threading the other), which allows positioning of the coupler on a pipe end without requiring the pipe ends to be separated axially and temporarily during assembly, and without requiring any special tools.

The above as well as additional objectives, features, and advantages of the present invention will become apparent in the following detailed written description.

### BRIEF DESCRIPTION OF THE DRAWINGS

The present invention may be better understood, and its numerous objects, features, and advantages made apparent to those skilled in the art by referencing the accompanying drawings.

FIG. 1 is a cross-section of a prior art retaining collet used in a conventional stabtype pipe coupler;

FIG. 2 is a perspective view of a prior art metallic back-up ring used in conjunction with the retaining collet of FIG. 1;

FIG. 3 is a longitudinal cross-section of one embodiment of the pipe coupler of the present invention, shown fully installed on a pipe end;

FIG. 4 is an elevational view of one embodiment of a retaining collet used with the pipe coupler of FIG. 3;

FIG. 5 is a cross-section of the retaining collet of FIG. 4; and

FIG. 6 is a perspective view of one embodiment of a back-up ring used in conjunction with the retaining collet of FIGS. 4 and 5, within the pipe coupler of FIG. 3.

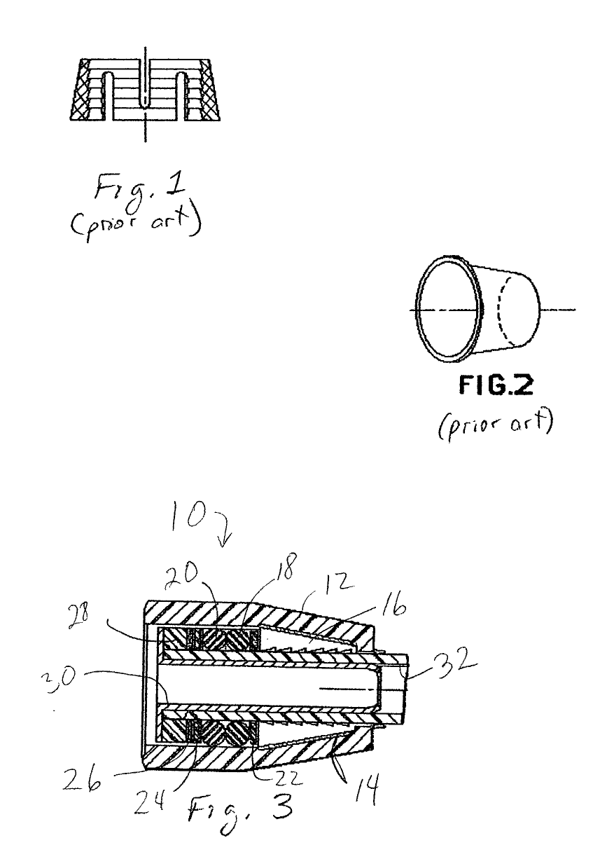

The use of the same reference symbols in different drawings indicates similar or identical items.

### DESCRIPTION OF THE PREFERRED EMBODIMENT(S)

With reference now to the figures, and in particular with reference to FIG. 3, there is depicted one embodiment 10 of a stab-type pipe coupler constructed in accordance with the present invention. Coupler 10 represents an improvement over the stab coupler described in U.S. Pat. No. 4,229,025, which is hereby incorporated. Additional details of the coupler of the present invention may be understood with reference to that patent.

Coupler 10 is generally comprised of a coupling body 12, a back-up ring 14, a gripping collet 16, a pair of 0-rings 18, 20, a pair of thrust washers 22, 24, a retaining ring 26, a spacer 28, and a stiffener member 30. Coupler 10 is shown installed on a pipe or tube 32. Coupling body 12 may be constructed of any durable material, preferably a polymer such as polyester or high-density polyethylene. Coupling body 12 is generally tubular, with inner and outer tapered surfaces at one end. The frusto-conical shape of back-up ring 14 allows ring 14 to become seated within the tapered end of coupling body 12. Back-up ring 14 surrounds and compresses gripping collet 16, whose outer surface is also frusto-conical. The inner surface of collet 16 is threaded in a manner discussed further below. O-rings 18, 20 provide a seal between coupling body 12 and pipe 32, and are positioned by thrust washers 22, 24, along with spacer 28. Stiffener member 30 is mostly disposed within pipe 32, and has a radially extending flange at one end which cooperates with the inner surface of coupling body 12 to center, align and maintain stiffener 30 at a concentric position with respect to the coupling body. The other end of stiffener member 30 is preferably chamfered to facilitate insertion of that end within pipe 32.

Referring now to FIG. 4, gripping collet 16 may also be constructed of any durable material, again preferably a polymer such as a polyamide. A plurality of longitudinal notches 40 are formed in collet 16 which allow compression of the collet such that the inner surface of collet 16 more tightly grips the outer surface of pipe 32. Thus, if a pull-out force is exerted on pipe 32, the resultant slight movement of pipe 32 will force the outer surface of collet 16 to be pushed against the tapered inner surface of back-up ring 14, which will in turn compress collet 16 further, thereby increasing frictional engagement between the inner surface of collet 16 and the outer surface of pipe 32.

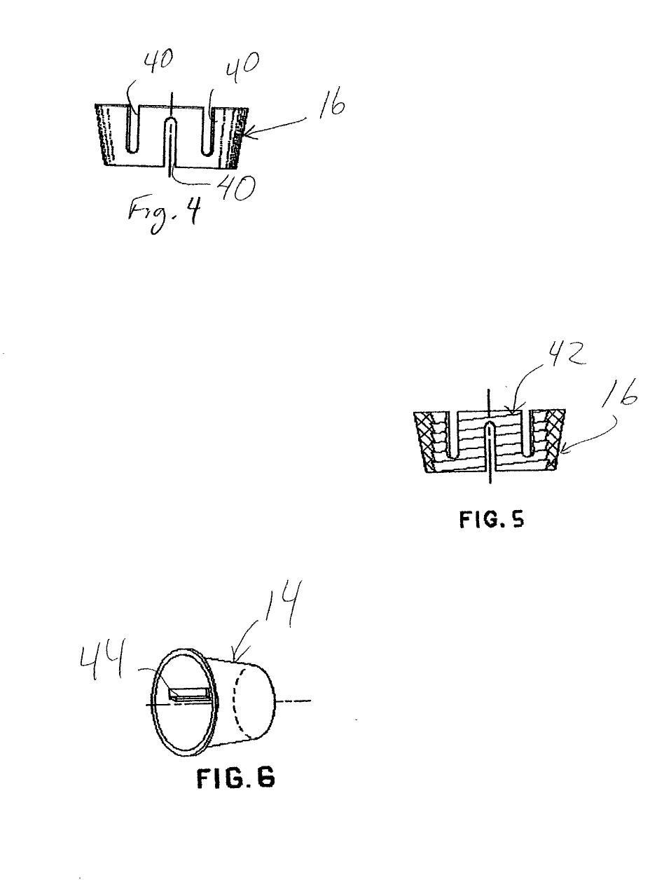

The threaded design of the inner surface of collet 16 is shown in FIG. 5. The threading 42 is preferably in the form of an interrupted buttress thread. A torque drive mechanism is provided to rotate collet 16 while it is engaging pipe 32. As discussed further in conjunction with FIG. 6, the torque drive mechanism may be located between collet 16 and coupling body 12. The threaded construction of the inner gripping surface of collet 16 allows positioning of pipe 32 within coupler 10 during assembly or at a later time (when exterior loads or interior pressures are not on present) by pushing it on (until a stop point is hit), and then threading collet 16 backwards (toward the pipe end). The threading can be achieved manually, i.e., without the use of any special tools.

Back-up ring 14 is further depicted in FIG. 6. As shown in that figure, in the preferred embodiment, the torque drive mechanism for collet 16 takes the form of an inwardly extending, longitudinal flange 44 which is stamped out of the material of back-up ring 14. Flange 44 engages one of the notches 40 in collet 16 to prevent relative rotation while allowing axial motion. Thus, the craftsperson may firmly grasp pipe 32 with one hand while turning back-up ring 14 with the other hand, to induce rotation of collet 16 about the pipe, which also moves collet 16 longitudinally along the pipe due to engagement with threading 42. After assembly and during service, axial forces will not cause significant rotation, and the pipe will be properly retained. Although rotational forces may occur in service, they are not of sufficient magnitude to result in multi-turn rotation.

The foregoing construction allows the possibility of intentional coupler removal at any time that the coupling is not under a large axial load. The torque drive does allow hand turning of the collet when under a deliberate mild axial load (prior art installation techniques include pre-loading the collet to obtain a positive gripping force). One advantage of providing such a removable coupler is that the coupler is reusable. Also, it can be moved in both directions along the pipe during assembly (pushing one direction, threading the other). This feature allows positioning of the coupler on a pipe end without requiring the pipe ends to be separated axially and temporarily during assembly, which may be particularly important during repair, where only short ends of a buried or otherwise obscured pipe may be free of restraint. For such an application, a variation of the foregoing design may be used with twice the engagement length on one end, so the pipe can be inserted twice the engagement length, and the opposite end of the coupler engaged by threading the first end back to one engagement length.

The present invention has additional advantages as well. A temporary short piece of pipe with a plug in one end welded shut can be installed on the coupler. At a later date, the pipe with plug can be threaded off and a new pipe easily installed. This approach is useful in planned expansion of a utility distribution system, and negates the need for an end cap. Also, pressure and other functional tests can be performed on the coupling using temporary fittings and (if the tests are non-destructive) then the coupling may be placed in service with full confidence. This reusability negates the need for several patents such as U.S. Pat. Nos. 6,050,613 and 4,628,965.

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. For example, other torque drive mechanisms may be provided to induce rotation of collet 16 and engage the threading. Surface features could be provided on back-up ring 16 besides the longitudinal flange. The mechanism need not even be integral to back-up ring 14; rather, mechanical features may be provided on other coupler parts such as coupling body 12. It is therefore contemplated that such modifications can be made without departing from the spirit or scope of the present invention as defined in the appended claims.

What is claimed is:

1. A method of installing a coupler on a pipe end, comprising the steps of:
pushing a gripping collet onto an outer surface of the pipe end in a first direction, wherein the gripping collet has threading along an inner surface thereof, adapted to engage the outer surface of the pipe end;
adjusting a location of the gripping collet along the pipe end by rotating the gripping collet to induce longitudinal movement thereof in a second direction which is opposite the first direction by engagement of the threading with the outer surface of the pipe.

2. The method of claim 1 wherein said adjusting step includes the step of turning a back-up ring which is mechanically engaged with the gripping collect.

3. The method of claim 2 wherein said adjusting step further includes the step of aligning an inwardly extending, longitudinal flange of the back-up ring with a notch formed in the gripping collet.

4. The method of claim 3 wherein the back-up ring has an inner surface with a frusto-conical shape that matches a frusto-conical shape of an outer surface of the gripping collet, and further comprising the step of forcibly pushing the gripping collet inside the back-up ring to compress the gripping collet toward the pipe end.

5. The method of claim 1 further comprising the step of inserting a stiffener member inside the pipe end such that a portion of the stiffener member is surrounded by the gripping collet.

6. The method of claim 1 further comprising the step of surrounding the collet and pipe end with a coupling body.

7. The method of claim 7 further comprising the step of providing a seal between the coupling body and the pipe end.

8. An article for coupling a pipe end, comprising:
means for gripping an outer surface of the pipe end to oppose a pull-out force on the pipe end in a first direction; and
means for rotating said gripping means to induce longitudinal movement of said gripping means along the pipe end in a second direction which is opposite the first direction.

9. The article of claim 8 wherein said gripping means includes a collet having an inner surface which engages the pipe end.

10. The article of claim 9 wherein said inner surface of said collet is threaded.

11. The article of claim 10 wherein said threaded inner surface of said collet has an interrupted buttress thread.

12. The article of claim 10 wherein said collet further has a plurality of longitudinal notches.

13. The article of claim 12 where in said rotating means includes an inwardly extending, longitudinal flange formed on a back-up ring which surrounds said collet, said flange engaging one of said notches.

14. The article of claim 8 wherein:
said gripping means includes a collet having an inner surface which engages the pipe end; and
said rotating means includes a back-up ring which mechanically engages said collet.

15. The article of claim 14 wherein said back-up ring has an inner surface with a frusto-conical shape that matches a frusto-conical shape of an outer surface of said collet, such that when said collet is forced against said backup-ring, said collet is further compressed toward the pipe end.

16. The article of claim 15 further comprising a coupling body adapted to surround said back-up ring and said collet, said coupling body having a tapered inner surface that matches a frusto-conical shape of an outer surface of said back-up ring.

17. A stab-type pipe coupler comprising:
a gripping element for engaging an outer surface of a pipe end; and
a torque drive mechanism for rotating the gripping element about the outer surface of the pipe end.

18. The stab-type pipe coupler of claim 17 wherein:
said gripping element is a collet having a threaded inner surface; and
said torque drive mechanism is a back-up ring engaged with said collet.

19. The stab-type pipe coupler of claim 18 wherein:
said collet has at least one longitudinal notch; and
said back-up ring has an inwardly extending, longitudinal flange which engages said notch.

20. The stab-type pipe coupler of claim 19 wherein said threaded inner surface of said collet has an interrupted buttress thread.

21. A pipe coupler comprising:
a tubular coupling body having a tapered inner surface at one end;
a stiffener member adapted for insertion in a pipe end;
a collet having a frusto-conical outer surface, a threaded inner surface adapted to grip an outer surface of the pipe end which is supported by said stiffener member, and a plurality of longitudinal notches, said collet being located within said coupling body;
a frusto-conical back-up ring located between said inner surface of said coupling body and said frusto-conical outer surface of said collet, said back-up ring having an integral, inwardly extending, longitudinal flange engaging one of said notches, such that rotation of said back-up ring results in rotation of said collet;
one or more sealing rings adjacent said collet and surrounding a portion of said stiffener member;
one or more washers positioning said one or more sealing rings; and
a spacer for locating said one or more washers.
